(19) United States
(12) Patent Application Publication
(10) Pub. No.: US 2004/0258489 A1
(43) Pub. Date: Dec. 23, 2004

(54) Rotary milling cutter

(76) Inventor: Vladimir Volokh, Ma'alot (IL)

Correspondence Address: Eitan Pearl Latzer& Cohen Zedek, 10 Rockefeller Plaza, Suite 1001, New Youk, NY, 10020, US

(21) Appl. No.: 10/494,575

(22) PCT Filed: Nov. 6, 2002
(86) PCT No.: PCT/IL02/00888

(30) Foreign Application Priority Data
Nov. 6, 2001 (IL) I46370

(51) Int. Cl. B23C 5/00

(52) U.S. Cl. 407/53

(57) ABSTRACT

The Invention relates to tools for the machining of materials by milling. The invention provides an improved form for a rotary cutting tool such as an end-mill, configured to extend tool life while increasing metal removal rates.The invention provides a rotary multi-tooth cutter, the cutting edge of each tooth being provided along its length with a repeated wave form, comprising four substantially straight sections interconnected by mill, the first section being identical with the unmodified cutting edge. The second section adjoins the first section on a side nearer the tool shank and extending at an angle to the first section into the tooth. The third section, adjoining the first section on a side nearer the tool tip, extends at an angle to the first section into the tooth. The fourth section is connected to the third section extending into the tooth at an angle greater than the third section. A root radius connecting the fourth section to the adjoining second section of the adjacent form.

### FIELD AND BACKGROUND OF THE INVENTION

The present invention relates to tools for the machining of materials by milling. More particularly, the invention provides an improved form for a rotary cutting tool such as an end-mill, configured to extend tool life while increasing metal removal rates.

End-mills are widely used in milling operations due to their versatile range of application and due to the moderate first cost of the tool. End-mills are often of cylindrical shape, and are available up to about 80 mm diameter. Many end mills have flat ends; however other shapes such as conical and rounded ends are also used. An end-mill typically has 2 to 10 teeth, depending on diameter size and whether for rough cutting or finishing. Teeth are usually of spiral shape, but can be straight parallel to the axis. Material of construction is high speed steel, solid carbide, cermet or ceramic, or combinations thereof.

It has long been known that in many machining operations end-mill performance is improved by serration of the cutting edge. Cutters of this type are listed in tool catalogues and are available off the shelf. There is however no consensus regarding the optimum form of said serration. A common form is the sine wave, this being one of the forms suggested by Wale in U.S. Pat. No. 4,764,059, which discloses a helical inserted-blade cutter. A short pitch serration is seen on the Nicked Cutting Tool disclosed by Nishimura in U.S. Pat. No. 5,193,944.

A sine wave shape has theoretically no straight section at all, although in practice a small section at the 180 degree point is almost straight. When meeting a flat surface, contact between the sine wave and flat surface is therefore concentrated at a point. Such contact produces extreme pressure when the flat surface is a hard workpiece and the sine wave is a form imposed on the cutting edge of an end-mill tooth. It is reasonable to conclude that this point contact is responsible for shortening the life of this type of cutting tool.

### OBJECT OF THE INVENTION

It is therefore one of the objects of the present invention to obviate the disadvantages of prior art cutting tools and to provide a cutter which makes line contact with the workpiece while yet retaining the advantages, such as improved chip disposal, of the serrated tooth form.

### SUMMARY OF THE INVENTION

The present invention achieves the above objects by providing a rotary multi-tooth cutter, the cutting edge of each tooth being provided along its length with a repeated wave form, said wave form comprising four substantially straight sections interconnected by radii, a first section being identical with the unmodified cutting edge. A second section adjoins the first section on a side nearer the tool shank and extending at an angle to said first section into the tooth. A third section, adjoining the first section on a side nearer the tool tip, extends at an angle to the first section into the tooth. A fourth section is connected to said third section extending into the tooth at an angle greater than said third section, a root radius connecting the fourth section to the adjoining second section of the adjacent form.

### PREFERRED EMBODIMENT OF THE INVENTION

In a preferred embodiment of the present invention there is provided a cutter wherein the third section is substantially parallel to the tool axis.

In a most preferred embodiment of the present invention there is provided a cutter configured for use in the machining of hard metals, wherein the third section has a length of about 15% to 40% of the pitch of the repeated wave.

The present invention provides significant improvement in cutting action and longer tool life because the profile of the cutting edge is optimized in accordance with cutting tool material, work piece material, and cutting conditions such as high speed or conventional cutting.

A single pitch of the repeated wave form contains the following sections.

A linear portion ( c ) is disposed at 0 degrees helix angle. This portion first penetrates the work piece along its whole length at one time. Pressure at the penetration area is lower in comparison with cutters having point penetration. Cutting forces are lower than with tools making point contact with the workplace. Located at the sides of the linear portion ( c ) are a right hand helix portion (d) and a left hand helix portion (a). Portion (b) has a larger left hand helix angle than portion (a). The four portions (a b c d), which are linked by radii, comprise 1 pitch.

The resulting geometry assures line penetration, which exerts lower local forces on the cutting tool than point penetration. The length of the linear portion ( c ), the pitch and other dimensions can be determined by the material to be machined (hard steels, medium and soft hardened steels, stainless steel, high temperature alloys, titanium, aluminium) as well as cutting tool material (High speed steel, solid carbide, ceramics) and machining conditions.

Tool life is extended and chips are produced which are easily evacuated.

It will thus be realized that the novel cutter of the present invention is provided with a profile wherein the third section of the repeating wave form makes line contact with a workplace to greatly reduce impact pressure during machining. The achieved cutting pressure reduction reduces cutter wear, lengthens tool life and increases possible metal removal rates.

The length of said third section can be selected after consideration of the machinability of the material to be machined. For soft metals such as copper and aluminium the third section can be short, about 8% to 20% of the wave pitch. Where hard metals, alloy or stainless steels for example are to be machined, the third section is substantially longer, typically around 15 to 40% of the wave pitch.

For roughing cutters expected to remove material at the highest possible rate there is provided an embodiment wherein an additional wave form is imposed on the relief surface of the tooth.

### SHORT DESCRIPTION OF DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a perspective, non-detailed view of a preferred embodiment of the cutter according to the invention;

FIG. 2 is an enlarged view of one pitch of the repeated wave profile ground in each of the cutter teeth;

FIGS. 3 and 4 are a detail perspective view of an embodiment wherein the wave form extends also over the relief surface;

FIG. 5 is a table providing a numerical example of the wave-form suitable for machining mild steel; and

FIG. 6 is a detail perspective of an embodiment wherein each tooth has a waveform imposed on its rake surface, with an additional concave portion.

### FULL DESCRIPTION OF THE INVENTION

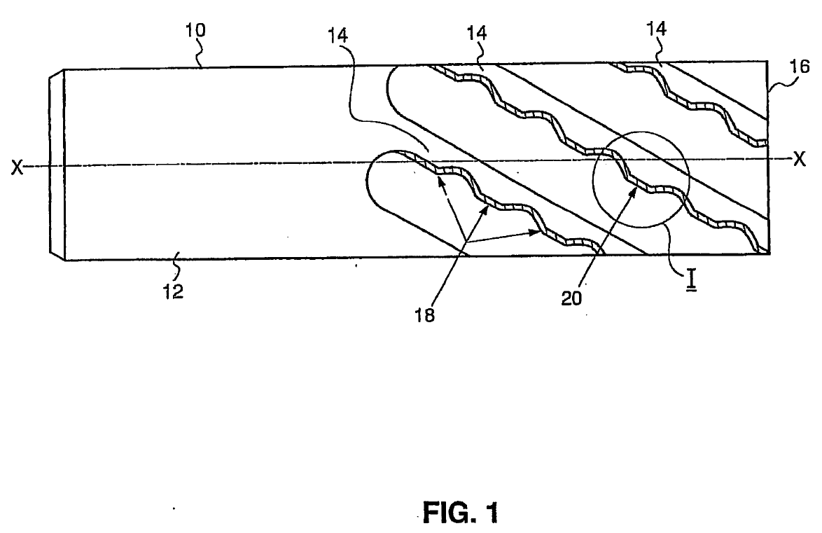

There is seen in FIG. 1 a rotary multi-tooth cutter 10, having a shank 12, a plurality of teeth 14 and a-tip 16. The cutting edge 18 of each tooth is provided along its length with a repeated wave form 20. The cutter 10 shown is in the form of an end mill. Typically the cutter 10 is made of conventional materials, high speed steel, tungsten carbide, or combinations thereof. The teeth 14 can, as prior-art cutters, be coated with a prior-art thin hard coating, for example of titanium nitride, to prolong tool life.

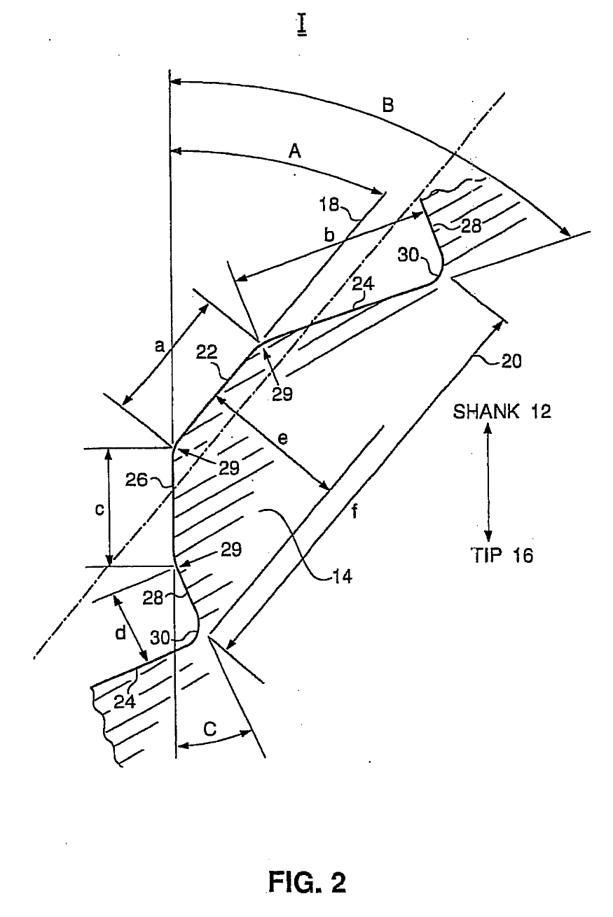

Referring now to FIG. 2, there is seen on a large scale a single pitch of the repeated wave form 20, its length designated by the letter i. The wave form 20 comprises of four substantially straight sections 22, 24, 26, 28 interconnected by radii 29.

A first section 22 is identical with the unmodified cutting edge. Its length is designated by the arrow a.

A second section 24, its length marked by the arrow b, adjoins the first section 22 on a side nearer the tool shank 12. The second section 24 also serves as a cutting edge and extends at an angle B-A to the first section, into the tooth 14.

A third section 26, its length marked by the arrow c, also adjoins the first section 22, but on a side nearer the tool tip 16. The third section 26 extends at an angle A to the first section into the tooth. The third section 26 is also a cutting edge. Advantageously the third section 26 is parallel to the tool axis XX seen in FIG. 1. A fourth section 28 is a relief section and is not used as a cutting edge. The fourth section 28—its length designated by the letter d, is connected to the third section 26, and extends into the cutter tooth 14 at an angle C. As angle C is always positive, the fourth section 28 extends into the tooth 14 at an angle greater than does the third section 26.

A root radius 30, marked by arrow r, connects the fourth section 28 to the adjoining second section 24 of the adjacent wave. Total wave depth (amplitude) is designated by arrow e.

The following are preferred relationships which form the basis of the special profile described.

The pitch of the repeated wave form 20, f, exceeds 15% of the cutter diameter.

The amplitude, e, of the repeated wave form 20 is less than 25% of the pitch of the repeated wave.

Where soft metals are to be machined, the third section 26 has a length of about 8% to 20% of the pitch of the repeated wave.

Where hard metals are to be machined, the third section 26 has a length of about 15% to 40% of the pitch of the repeated wave.

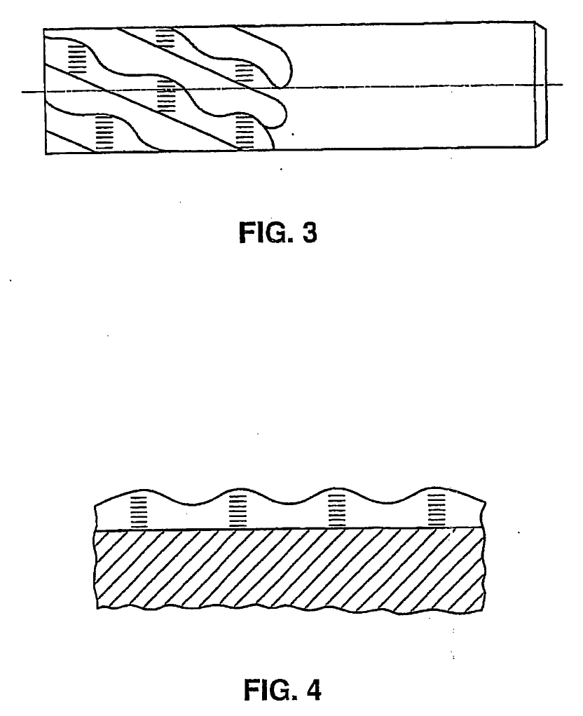

With regard to FIGS. 3 & 4, similar reference numerals have been used to identify similar parts.

FIG. 3 illustrates a segment of an end-mill tooth 14 wherein the repeated wave form 20 is on the relief face 32, and the rake surface seen in FIG. 1, of each tooth 14. The picks and valleys on the rake surface and the picks and valleys on the relief surface have the same location along the cutting edge.

This is particularly advantageous in roughing tools, as higher rates of metal removal can be achieved thereby.

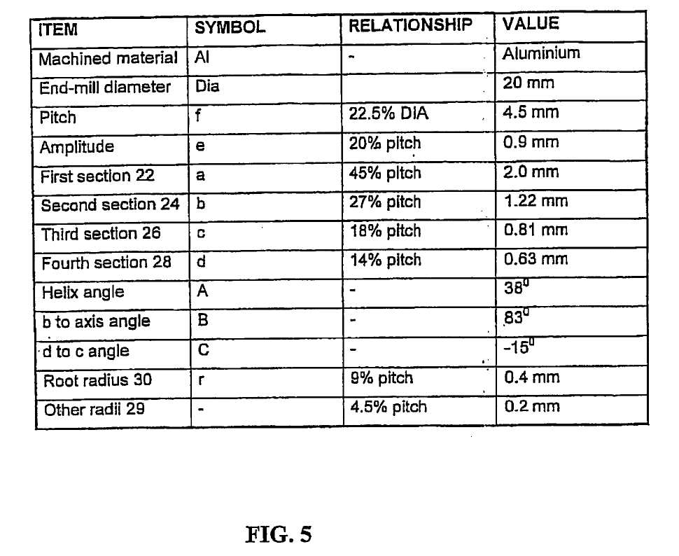

Referring now to FIG. 5, there is given a numerical example, wherein a 20 mm diameter end-mill is to be used to machine aluminium.

FIG. 5 Numerical example

| ITEM | SYMBOL | RELATIONSHIP | VALUE |
|---|---|---|---|
| Machined material | Al | — | Aluminium |
| End-mill diameter | Dia | | 20 mm |
| Pitch | f | 22.5% DIA | 4.5 mm |
| Amplitude | e | 20% pitch | 0.9 mm |
| First section 22 | a | 45% pitch | 2.0 mm |
| Second section 24 | b | 27% pitch | 1.22 mm |
| Third section 26 | c | 18% pitch | 0.81 mm |
| Fourth section 28 | d | 14% pItch | 0.63 mm |
| Helix angle | A | — | 38° |
| b to axis angle | B | — | 83° |
| d to c angle | C | — | −15° |
| Root radius 30 | r | 9% pitch | 0.4 mm |
| Other radii 29 | — | 4.5% pitch | 0.2 mm |

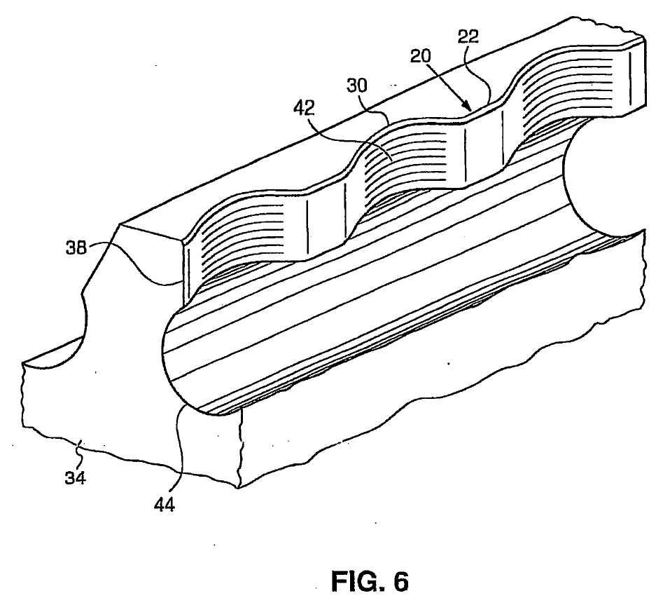

FIG. 6 shows an embodiment of cutter intended for minimum contact of chips with rake surface and better chip evacuation.

The helical tooth 34 is shown as if straight for illustrative purpose.

Each tooth 34 has a wave-form imposed on its rake surface 38 according tot he wave form 20 of the cutting edge.

A concave portion 44 without repeated wave-form connects the wave form 38 to the root of the tooth 34 and relief wave form 38.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

1. A rotary multi-tooth cutter, the cutting edge of each tooth being provided along its length with a repeated wave form, said form comprising four substantially straight sections interconnected by radii, a first section being identical with the unmodified cutting edge, a second section adjoining said first section on a side nearer the tool shank and extending at an angle to said first section into the tooth, a third section, adjoining said first section on a side nearer the tool tip, extending at an angle to said first section into the tooth, and a fourth section connected to said third section extending into said tooth at an angle greater than said third section, a root radius connecting said fourth section to the adjoining second section of the adjacent form.

2. The cutter as claimed in claim 1, wherein said third section is substantially parallel to the tool axis.

3. The cutter as claimed in claim 1, wherein said repeated wave-form extends also on the relief surface.
Picks and valleys on rake surface and on relief surface have same location along Cutting edge.

4. The cutter as claimed in claim 1, wherein the pitch of said repeated wave form exceeds 7% of the cutter diameter.

5. The cutter as claimed in claim 1, wherein the amplitude of said repeated wave form is less than 25% of the pitch of the repeated wave.

6. The cutter as claimed in claim 1, configured for use in the machining of soft metals, wherein said third section has a length of about 8% to 20% of the pitch of the repeated wave.

7. The cutter as claimed in claim 1, configured for use in the machining of hard metals, wherein said third section has a length of about 8% to 40% of the pitch of the repeated wave.

8. The cutter as claimed in claim 1 on rake surface have additional concave portion without repeated wave-form, that relief repeated wave form surface on rake surface of cutter.
